(19) United States
(12) Patent Application Publication
(10) Pub. No.: US 2011/0153895 A1
(43) Pub. Date: Jun. 23, 2011

(54) IMAGE PROCESSING APPARATUS, IMAGE PROCESSING SYSTEM AND COMPUTER READABLE MEDIUM

(75) Inventor: Hideaki TAKAYAMA, Saitama (JP)

(73) Assignee: FUJI XEROX CO., LTD., Tokyo (JP)

(21) Appl. No.: 12/813,995

(22) Filed: Jun. 11, 2010

(30) Foreign Application Priority Data
Dec. 22, 2009 (JP) 2009-290769

(51) Int. Cl. G06F 12/00; G06F 13/38

(52) U.S. Cl. 710/301; 711/154; 711/E12.001

(57) ABSTRACT

An image processing apparatus includes an attachment unit, an image processing unit, a storage unit, a discrimination unit and a control unit. A memory unit storing at least one piece of information is detachably attached to the attachment unit. The image processing unit performs image processing. The storage unit stores the information stored in the memory unit through the attachment unit or stores a result of processing executed by the image processing unit. The discrimination unit discriminates processing information inputted externally for instructing the image processing unit to execute processing. The control unit controls a process of transferring the information stored in the memory unit or the result of processing executed by the image processing unit and stored in the storage unit in accordance with a result of discrimination executed by the discrimination unit.

### CROSS-REFERENCE TO RELATED APPLICATION

This application is based on and claims priority under 35 USC 119 from Japanese Patent Application No. 2009-290769 filed on Dec. 22, 2009.

### BACKGROUND

1. Technical Field

The present invention relates to an image processing apparatus, an image processing system and a computer readable medium.

2. Related Art

There is an increasing number of cases where document data, image data, etc. are stored in a portable USB (Universal Serial Bus) memory with the popularization of the USB memory as a kind of external storage device.

An image processing apparatus such as a multifunctional machine or a color printer which is equipped with a so-called USB memory print (also referred to as media print or the like) function for directly printing data stored in a USB memory and with a so-called USB memory scan (also referred to as scan-to-media or the like) function for storing data of a paper medium digitized by a scanner in a USB memory has been developed in order to cope with such circumstances.

There have been proposed various techniques concerned with such an image processing apparatus to which an external storage device is connected and which performs image processing.

### SUMMARY

According to an aspect of the invention, an image processing apparatus includes an attachment unit, an image processing unit, a storage unit, a discrimination unit and a control unit. A memory unit storing at least one piece of information is detachably attached to the attachment unit. The image processing unit performs image processing. The storage unit stores the information stored in the memory unit through the attachment unit or stores a result of processing executed by the image processing unit. The discrimination unit discriminates processing information inputted externally for instructing the image processing unit to execute processing. The control unit controls a process of transferring the information stored in the memory unit or the result of processing executed by the image processing unit and stored in the storage unit in accordance with a result of discrimination executed by the discrimination unit.

### BRIEF DESCRIPTION OF THE DRAWINGS

Exemplary embodiments of the invention will be described in detail based on the following figures, wherein:

FIG. 1 is an external view showing the schematic configuration of an image processing apparatus PR1 according to an embodiment of the invention;

FIG. 2 is a functional block diagram showing the functional configuration of the image processing apparatus PR1 according to the embodiment;

FIG. 3 is an explanatory view showing an example of a flow of processing in the image processing apparatus PR1 according to the embodiment; and

FIG. 4 is an explanatory view showing another example of a flow of processing in the image processing apparatus PR1 according to the embodiment.

### DETAILED DESCRIPTION

An embodiment of the invention will be described below in detail with reference to the drawings. In the accompanying drawings, the same parts can be indicated by the same reference numerals, and duplicate description thereof will be omitted. Although description here will be made on the best embodiment of the invention, the invention is not limited to the embodiment.

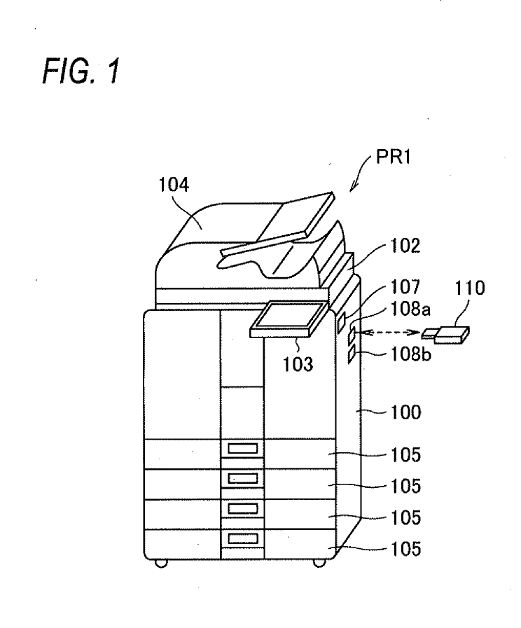

Referring to FIGS. 1 to 4, an image processing apparatus PR1 according to the embodiment of the invention will be described.

Incidentally, the image processing apparatus PR1 according to this embodiment is a so-called multifunctional machine equipped with a printer function, a scanner function, etc.

As shown in FIG. 1, a platen plate 102 and a notification portion 103 (as an example of a notification unit) which performs various kinds of displays and operations are provided in an upper portion of a body 100 of the image processing apparatus. An automatic document feeder device 104 is provided on the platen plate 102.

For example, the notification portion 103 is constituted by a liquid crystal touch panel, etc. which includes a start key, a ten-key pad, a copy key, a scan key, a print key, a facsimile key, a display screen, etc.

Storage cassettes 105 in which printing paper sheets with various sizes are stored respectively are provided in a lower portion of the body 100.

A paper output unit (not shown) which receives sheets of paper output after printing may be provided in a side of the body 100.

A power switch 107 and USB ports (host USB ports 108a and 108b each as an example of an attachment unit) are provided in the other side of the body 100.

A USB memory 110, a USB-connected hard disk drive (not shown) or the like as a memory unit for storing at least one piece of information is connected to each of the host USB ports 108a and 108b.

There are a scanner function and a USB memory print function as main functions of the body 100.

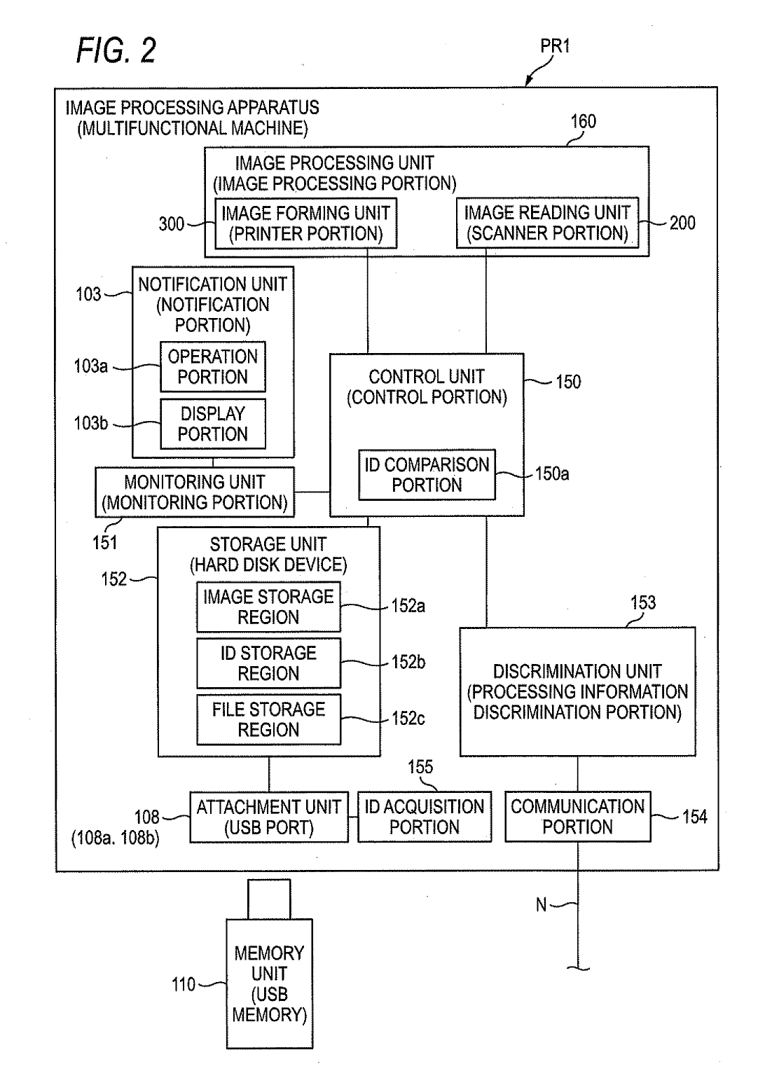

The scanner function is classified into a so-called scan-to-file function, a so-called scan-to-mail function, a so-called USB memory scan function, etc. The scan-to-file function is a function by which image data scanned by a scanner portion 200 (as an example of an image reading unit: see FIG. 2) provided in the body 100 are stored in a hard disk device 152 (as an example of a storage unit) in the body 100 or stored in an external device. The scan-to-mail function is a function by which image data scanned by the body 100 are sent to an external device in an electronic mail form. The USB memory scan function is a function by which image data scanned by the body 100 are stored in the USB memory 110.

The USB memory print function is a function by which image data fed from the USB memory 110 to the body 100 are printed by a printer portion 300 (as an example of an image forming unit: see FIG. 2) provided in the body 100.

The USB memory will be described below in brief.

The USB memory is a small-size storage device having a built-in flash memory as a kind of nonvolatile memory which is used in a state where it is connected to a USB port (USB connector).

The USB standard includes originally a specification called “USB Mass Storage Class” for recognizing a hard disk drive or the like as a removable drive. Almost all USB memories are based on this specification.

The functional configuration of the image processing apparatus PR1 will be described next with reference to FIG. 2. Incidentally, for the sake of omission of description, the same reference numerals are given to the same parts as those in the configuration described with reference to FIG. 1.

The image processing apparatus PR1 includes: an image processing portion 160 (as an example of an image processing unit) which performs image processing; a hard disk device 152 (as an example of a storage unit) which stores information stored in the USB memory 110 through a USB port 108 or stores a result of processing executed by the image processing portion 160; a processing information discrimination portion 153 (as an example of a discrimination unit) which discriminates processing information inputted externally for instructing the image processing portion 160 to execute processing; a control portion 150 (as an example of a control unit) which is constituted by a micro-computer or the like for controlling a process of transferring the information stored in the USB memory 110 or the result of processing executed by the image processing portion 160 and stored in the hard disk device 152, in accordance with a result of discrimination executed by the processing information discrimination portion 153; a communication portion 154 which is constituted by a network interface or the like for communicating with a network N such as an LAN or the Internet; an ID acquisition portion 155 which acquires ID (identification information) stored in the USB memory 110; a monitoring portion 151 (as an example of a monitoring unit) which monitors a condition of reading information from the USB memory 110 or a condition of writing the result of processing into the USB memory 110; and a notification portion 103 (as an example of a notification unit) which gives notification as to whether the USB memory 110 can be detached from the USB port 108 or not, in accordance with a result of monitoring executed by the monitoring portion 151.

As described above, the image processing portion 160 has the scanner portion 200, and the printer portion 300.

The notification portion 103 constituted by a liquid crystal touch panel or the like as described above has the operation portion 103a and the display portion 103b.

The control portion 150 has an ID comparison portion 150a which compares ID's acquired by the ID acquisition portion 155.

An image storage region 152a for storing image information read by the scanner portion 200 and image information inputted from the USB memory 110, an ID storage region 152b for storing ID acquired by the ID acquisition portion 155 and a file storage region 152c for storing file information inputted from the USB memory 110 are at least provided in the hard disk device 152.

Identification information (ID) of each USB device inclusive of a USB memory will be described below in brief.

The serial number “iSerialNumber” of each USB device is stored in detailed information called Descriptor of each device.

More specifically, the presence/absence of information is stored in Device Descriptor and the contents of information are stored in String Descriptor.

Besides these, iManufacturer and iProduct are provided as identification information of each device.

Each USB device is identified based on these iManufacturer, iProduct and iSerialNumber.

The control portion 150 may perform control so that information stored in the USB memory 110 is stored in the hard disk device 152 when the processing information discrimination portion 153 determines that processing information is an instruction to execute an input process from the USB memory 110 to the image processing portion 160.

Information stored in the USB memory 110 may contain identification information (ID) for identifying the USB memory 110. In this case, the control portion 150 may perform control so that information stored in the USB memory 110 is stored in the hard disk device 152 and other information than the identification information (ID) is deleted from the USB memory 110 when the processing information discrimination portion 153 determines that processing information is an instruction to execute an input process from the USB memory 110 to the image processing portion 160, and that the information stored in the hard disk device 152 is restored to the USB memory 110 only when the identification information (ID) stored in the hard disk device 152 coincides with the identification information (ID) stored in the USB memory 110 in the case where the USB memory 110 is detached from the USB port 108 and then attached to the USB port 108 again.

The control portion 150 may perform control so that the result of processing executed by the image processing portion 160 and stored in the hard disk device 152 is stored in the USB memory 110 when the processing information discrimination portion 153 determines that processing information is an instruction to execute an output process from the image processing portion 160 to the USB memory 110.

Information stored in the USB memory 110 may contain identification information (ID) for identifying the USB memory 110. In this case, the control portion 150 may perform control so that identification information (ID) is stored in the ID storage region 152b of the hard disk device 152 when the processing information discrimination portion 153 determines that processing information is an instruction to execute an output process from the image processing portion 160 to the USB memory 110, and that the result of processing executed by the image processing portion 160 and stored in the hard disk device 152 is stored in the USB memory 110 only when the identification information (ID) stored in the hard disk device 152 coincides with the identification information (ID) stored in the USB memory 110 in the case where the USB memory 110 is detached from the USB port 108 and then attached to the USB port 108 again.

The control portion 150 may perform control so that the result of processing executed by the image processing portion 160 and stored in the hard disk device 152 is stored in the USB memory 110 and then the information is deleted from the hard disk device 152.

Notification as to whether the USB memory 110 can be detached from the USB port 108 or not, may be given as a message on the display portion 103b of the notification portion 103 in accordance with a result of monitoring executed by the monitoring portion 151.

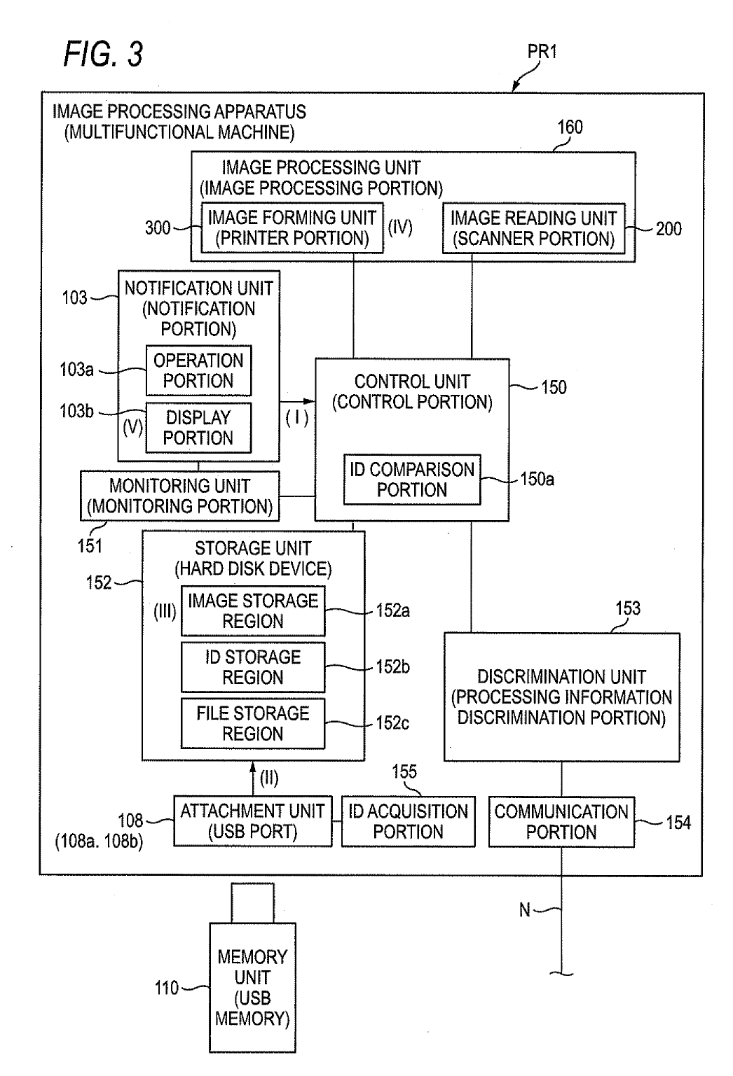

An example of a flow of processing in the image processing apparatus PR1 according to this embodiment will be described next with reference to FIG. 3.

First, in step (I), a user attaches a USB memory 110 to a USB port 108 and operates the operation portion 103a to give an instruction to execute “media print”. On this occasion, the user selects files in the USB memory 110 to start a job.

Then, in step (II), the designated files are read through the USB port 108 and storage of the designated files in the file storage region 152c of the hard disk device 152 is started. This process is executed at a relatively high speed because this process is chiefly for transfer of the data.

When the process of the step (II) is started, the image processing portion 160 reads files stored in the hard disk device 152 successively and performs processing page by page.

Image data stored in the image storage region 152a of the hard disk device 152 are read by the image processing portion 160 (step (III)), and printed by the printer portion 300 (step (IV)). This process is executed at a relatively low speed because high-grade arithmetic processing is required.

Then, when the reading of the step (II) is completed, notification indicating that the USB memory 110 can be disconnected and detached from the USB port 108 is displayed on the display portion 103b (step (V)).

Thereafter, the aforementioned processing is repeated until no unprocessed data remain in the file storage region 152c.

Accordingly, because the USB memory 110 can be removed from the image processing apparatus PR1 before completion of the whole image processing at the time of execution of “media print”, the time required for user's monitoring a condition of attaching the USB memory 110 to the image processing apparatus PR1 can be shortened so that user-friendliness is improved.

Because the USB memory 10 need not be left as it is even when the user has to leave the image processing apparatus PR1, security can be improved compared with the case where the invention is not applied.

That is, in an image processing apparatus according to the background art as a subject of comparison, it is conceived that the user may leave the spot before completion of the job when the USB memory scan function is executed on a great deal of documents.

This is because when the USB memory scan function is executed, it is necessary to execute a process of converting image data into a format of PDF or the like and writing the converted image data into the USB memory after completion of the operation of scanning a great deal of documents, so that a long time may be required for executing the process of converting and writing the image data of such a great deal of documents.

It is also conceived that the user having executed the USB memory print function may take only printed paper media and leave the spot while the USB memory itself is left in the image processing apparatus.

Accordingly, when a job such as the USB memory scan function or the USB memory print function is completed, the user may forget to pull out the USB memory.

That is, although it was possible to store various data inclusive of confidential information in the USB memory, the USB memory had to be mounted continuously until completion of the job after the job using the USB memory was started. For this reason, there was a security problem when the user must leave the site of the image processing apparatus.

According to the image processing apparatus PR1 according to this embodiment, security is improved because the USB memory 110 can be pulled out at proper time in accordance with notification indicating that the USB memory 110 can be detached from the USB port 108, as described above.

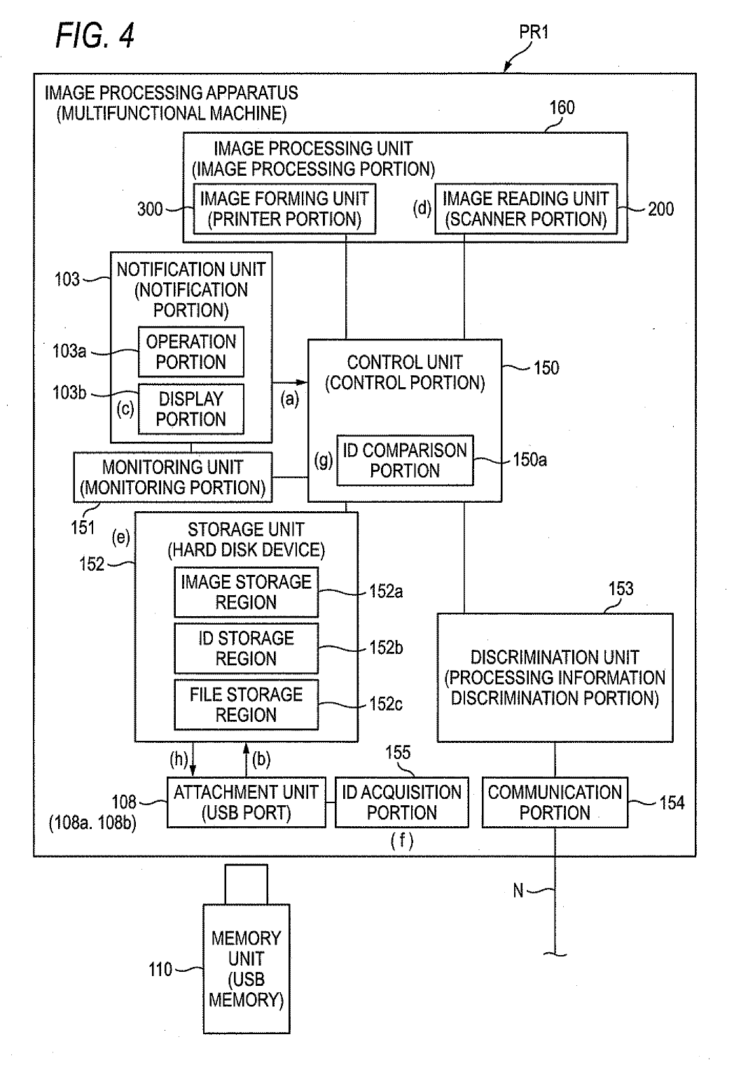

Another example of a flow of processing in the image processing apparatus PR1 according to this embodiment will be described next with reference to FIG. 4.

First, in step (a), the user attaches a USB memory 110 to a USB port 108 and operates the operation portion 103a to give an instruction to execute “scan-to-media”.

Then, when the job is started in step (b), the ID acquisition portion 155 acquires identification information (ID) from the USB memory 110 connected to the USB port 108 and stores the identification information (ID) in the ID storage region 152b of the hard disk device 152.

Then, when ID acquisition and storage is completed, notification indicating that the USB memory 110 can be disconnected is displayed on the display portion 103b (step (c)).

Then, the scanner portion 200 reads an image from each document (step (d)) and delivers the read image to the control portion 150. The control portion 150 generates image data by processing the read data and stores the generated image data in the image storage region 152a of the hard disk device 152 (step (e)).

On this occasion, the image storage region 152a transfers the image data to the USB memory 110 if the image data can be output to the USB memory 110.

Even if the USB memory 110 has been disconnected, image reading by the scanner portion 200 and image processing by the control portion 150 are executed continuously.

However, in this case, the image data are not transferred from the image storage region 152a to the USB memory 110.

Then, when the USB memory 110 is connected to the USB port 108 again, the ID acquisition portion 155 acquires identification information (ID) from the USB memory 110 connected to the USB port 108 (step (f)).

The ID comparison portion 150a compares the acquired ID with the ID stored in the ID storage region 152b, that is, the ID of the USB memory 110 which was attached to the USB port 108 when the job being currently executed was started (step (g)).

When the comparison results in detection of coincidence of ID's, the ID comparison portion 150a instructs the image storage region 152a to transfer the image data to the USB port 108 (step (h)).

On the other hand, when the comparison results in non-coincidence of ID's, this instruction is not issued.

As described above, when “scan-to-media” is executed, the USB memory 110 can be disconnected before completion of the whole document reading and image processing. Accordingly, even when the user has to leave the site of the image processing apparatus PR1, the USB memory 110 need not be left in the image processing apparatus PR1. For this reason, security is improved compared with the case where the invention is not applied.

Moreover, because image data are transferred in accordance with a simple operation of attaching the USB memory 110 which was used for starting the job, no troublesome data transfer operation is required so that user-friendliness is improved.

Moreover, information leakage caused by copying image data to a different USB memory can be prevented so that security is improved further.

Incidentally, image data and identification information (ID) may be stored not only in the hard disk device 152 built in the image processing apparatus PR1 but also in an external storage device or a network server connected through the USB port 108 or the communication portion 154.

Although this embodiment has been described in the case where the image processing apparatus PR1 is used as a multifunctional machine, the invention is not limited thereto. For example, the invention may be applied to a single scanner device, a single printer device, a combination of a scanner device and a printer device, etc.

Although this embodiment has been described in the case where the USB memory is used as a memory unit, the invention is not limited thereto. For example, the memory unit can be applied to various devices of general USB storage class, memory cards, non-contact storage media, etc.

Although the invention accomplished by the present inventor has been described above specifically based on the embodiment thereof, it should be considered that the embodiment disclosed in this specification is illustrative only in terms of all points and is not intended to limit the disclosed technique. That is, the technical scope of the invention should not be interpreted restrictively based on the description of the embodiment but should be interpreted in accordance with the description of the scope of the appending claims of the invention. The technical scope of the invention may include techniques equivalent to the techniques described in the scope of the appending claims of the invention and all changes in the scope of the appending claims of the invention.

When a program is used, the program can be provided through a network or can be provided after stored in a recording medium such as a CD-ROM.

That is, a predetermined program including an image processing program can be not only recorded on a storage device such as a hard disk as a recording medium but also provided as follows.

For example, the predetermined program may be stored in an ROM in advance so that the predetermined program is loaded from the ROM to a main storage device when the CPU executes the predetermined program.

Alternatively, the predetermined program may be distributed after stored in a computer-readable recording medium such as a DVD-ROM, a CD-ROM, an MO (magneto-optical disk), a flexible disk, etc.

In addition, an image forming apparatus or the like may be connected to a server apparatus or a host computer through a communication line (such as the Internet) so that the predetermined program is downloaded from the server apparatus or host computer, and then the predetermined program is executed. In this case, a memory such as an RAM and a storage device (recording medium) such as a hard disk can be listed as a downloading destination of the predetermined program.

The image processing apparatus, the image processing system and the processing program according to the invention can be applied to a printer, a multifunctional machine or the like including a scanner device.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image processing apparatus comprising:
an attachment unit to which a memory unit storing at least one piece of information is detachably attached;
an image processing unit that performs image processing;
a storage unit that stores the information stored in the memory unit through the attachment unit or stores a result of processing executed by the image processing unit;
a discrimination unit that discriminates processing information inputted externally for instructing the image processing unit to execute processing; and
a control unit that controls a process of transferring the information stored in the memory unit or the result of processing executed by the image processing unit and stored in the storage unit in accordance with a result of discrimination executed by the discrimination unit.

2. The image processing apparatus according to claim 1,
wherein the control unit performs control so that the information stored in the memory unit is stored in the storage unit when the discrimination unit determines that the processing information is an instruction to execute an input process from the memory unit to the image processing unit.

3. The image processing apparatus according to claim 1,
wherein the information stored in the memory unit includes identification information for identifying the memory unit, and
the control unit performs control so that (i) the information stored in the memory unit is stored in the storage unit and other information than the identification information is deleted from the memory unit when the discrimination unit determines that the processing information is an instruction to execute an input process from the memory unit to the image processing unit, and that (ii) the information stored in the storage unit is restored to the memory unit only when the identification information stored in the storage unit coincides with the identification information stored in the memory unit in the case where the memory unit is detached from the attachment unit and then attached to the attachment unit again.

4. The image processing apparatus according to claim 1,
wherein the control unit performs control so that the result of processing executed by the image processing unit and stored in the storage unit is stored in the memory unit when the discrimination unit determines that the processing information is an instruction to execute an output process from the image processing unit to the memory unit.

5. The image processing apparatus according to claim 1,
wherein the information stored in the memory unit includes identification information for identifying the memory unit, and
the control unit performs control so that (i) the identification information is stored in the storage unit when the discrimination unit determines that the processing information is an instruction to execute an output process from the image processing unit to the memory unit, and that (ii) the result of processing executed by the image processing unit and stored in the storage unit is stored in the memory unit only when the identification information stored in the storage unit coincides with the identification information stored in the memory unit in the case where the memory unit is detached from the attachment unit and then attached to the attachment unit again.

6. The image processing apparatus according to claim 4,
wherein the control unit performs control so that the result of processing executed by the image processing unit and stored in the storage unit is stored in the memory unit, and then the information is deleted from the storage unit.

7. The image processing apparatus according to claim 1, further comprising:
a monitoring unit that monitors a condition of reading the information from the memory unit or a condition of writing the result of processing into the memory unit; and
a notification unit that gives notification as to whether the memory unit can be detached from the attachment unit or not, in accordance with a result of monitoring executed by the monitoring unit.

8. The image processing apparatus according to claim 1,
wherein the image processing unit includes either of an image forming device which forms an image on a recording medium based on the information and an image reading device which reads a document and generates image information.

9. An image processing system comprising:
at least one image processing apparatus according to claim 1; and
at least one information processing apparatus connected to the image processing apparatus through a communication unit.

10. A computer readable medium storing a program causing a computer to execute an image process, the management process comprising:
storing information stored in a memory unit detachably attached through an attachment unit or a result of processing executed by an image processing unit, in a storage unit;
discriminating processing information for instructing the image processing unit to execute processing; and
controlling a process of transferring the information stored in the memory unit or the result of processing executed by the image processing unit and stored in the storage unit, in accordance with a result of discrimination in the discrimination step.
